(19) United States
(12) Patent Application Publication
(10) Pub. No.: US 2009/0079659 A1
(43) Pub. Date: Mar. 26, 2009

(54) MULTI-MODE RESONANT WIDEBAND ANTENNA

(75) Inventor: Sheng Hong Fang, Taoyuan City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Networks, Inc., Taoyuan City (TW)

(21) Appl. No.: 12/013,516

(22) Filed: Jan. 14, 2008

(30) Foreign Application Priority Data
Sep. 20, 2007 (TW) 096135232

(51) Int. Cl. H01Q 1/36

(52) U.S. Cl. 343/900

(57) ABSTRACT

A wireless transmit/receive unit for transmitting and receiving an electromagnetic wave and a method for the same are provided. The wireless transmit/receive unit includes a radiating element and a feeding line. The radiating element is a metal piece having a first edge with a first length, a second edge with a second length, and a plurality of cutouts. The first and second edges are separated from each other and the first length is longer than the second length. Further, the cutouts are formed on the metal piece respectively, which makes the metal piece have a zigzag shape. In addition, the feeding line is electrically connected to the second edge.

### FIELD OF THE INVENTION

The present invention relates to a wideband antenna and a manufacturing method for the same, and more particularly to a multi-mode resonant wideband antenna and a manufacturing method for the same.

### BACKGROUND OF THE INVENTION

The application of antenna in wireless LAN card is not only limited by the character of the antenna, but also by the space and the cost of the wireless LAN card. The chip antenna is usually applied in the wireless LAN card because of its small size. However, the chip antenna has the deficiencies of the high cost and the narrow bandwidth. Further, while the chip antenna is used in the wireless LAN card, the real bandwidth thereof is often narrower than expected because of the interference from the printed circuit board (PCB) layout.

If there is enough space in the wireless LAN card, the printed antenna is usually applied firstly. The printed antennas include the monopole antenna, the dipole antenna, the planar inverted-F antenna, and the ring antenna, wherein the planar inverted-F antenna is frequently used because it could efficiently reduce the size occupied by the printed antenna on PCB. Nevertheless, the bandwidth of the planar inverted-F antenna is always limited by the special structure itself. If the bandwidth of an antenna is not broad enough, the most electromagnetic wave delivered by the antenna would easily be reflected back by the surrounding objects that are close to the antenna. Further, the character of the return loss of the antenna is possible to be affected, which makes the deviation of the central frequency. For overcoming these deficiencies, an antenna that could provide a broader bandwidth and a better performance in return loss, and could overcome the affection of the surrounding objects to the return loss and the central frequency deviation, without any additional cost, is needed.

In order to overcome the drawbacks in the prior art, a multi-mode resonant wideband antenna and a manufacturing method for the same are provided. The particular design in the present invention not only solves the problems described above, but also is easy to be implemented. Thus, the invention has the utility for the industry.

### SUMMARY OF THE INVENTION

In accordance with the present i nvention, there is provided a wireless transmit/receive unit for transmitting and receiving an electromagnetic wave. The wireless transmit/receive unit includes a radiating element and a feeding line. The radiating element is a metal piece having a first edge with a first length, a second edge with a second length, and a plurality of cutouts. The first and second edges are separated from each other and the first length is longer than the second length. Further, the cutouts are formed on the metal piece respectively, which makes the metal piece have a zigzag shape. In addition, the feeding line is electrically connected to the second edge.

Preferably, the metal piece is an inverted triangle-shaped metal piece or inverted trapezium-shaped metal piece.

Preferably, the first length is a multiple of a quarter wavelength of the electromagnetic wave.

Preferably, the metal piece having the zigzag shape has an effective electrical length that is a multiple of a half wavelength of the electromagnetic wave.

Preferably, the cutouts being cutting slots have a total length that is a multiple of a half wavelength of the electromagnetic wave.

Preferably, the cutouts are formed by one of a cutting process and an etching process.

Preferably, each of the cutouts being cutting slots has a width of 20 milliinches.

Preferably, the feeding line is further mounted on a dielectric substrate.

Preferably, the wireless transmit/receive unit as further comprises a reference ground surface connected to the dielectric substrate.

Preferably, the dielectric substrate is made of FR4.

Preferably, the wireless transmit/receive unit is configured in a wireless transmission device.

In accordance with another aspect of the invention, there is provided a wideband antenna transmitting/receiving an electromagnetic wave. The wideband antenna includes a meander line and a feeding line. The meander line has a first terminal and a second terminal, and further includes a first section, a first bend part, a second section a second bend part, and a third section. The first section has a first length and is connected to the first terminal, and the second section has a second length and is connected to the first section via the first bending part. Moreover, the third section has a third length and is connected to the second section via the second bend part and is further connected to the second terminal. The first length is shorter than the second length, and the second length is shorter than the third length. In addition, the feeding line is electrically connected to the first terminal.

Preferably, the third length is a multiple of a quarter wavelength of the electromagnetic wave.

Preferably, the meander line has a total length that is a multiple of a half wavelength of the electromagnetic wave.

Preferably, the wideband antenna further comprises two slots between the first and second sections, and the second and third sections respectively, wherein each of the slots has a width of 20 milliinches.

Preferably, the feeding line is further mounted on a dielectric substrate.

Preferably, the wideband antenna further includes a reference ground surface, wherein the dielectric substrate is connected to the reference ground surface.

In accordance with a further aspect of the present invention, a method for increasing a bandwidth of an antenna is provided. The method includes the steps as follows. Firstly, a radiating element that has a first edge with a first length and a second edge with a second length is provided, and the first length is longer than the second length. Secondly, a plurality of cutouts are formed on the radiating element for producing a plurality of horizontal electric fields parallel to the cutouts and a plurality of vertical electric fields vertical to the cutouts, and the horizontal electric fields offset with each other and the vertical electric fields superimpose with each other.

Preferably, the cutouts are formed by one of a cutting process and an etching process.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is an illustrating diagram showing a multi-mode resonant wideband antenna according to the first preferred embodiment of the present invention;

FIG. 2 is an illustrating diagram showing a radiating element according to the second preferred embodiment of the present invention;

FIG. 3A is a polar graph showing an horizontal field pattern of the multi-mode resonant wideband antenna in the XZ plane according to the first preferred embodiment of the present invention;

FIG. 3B is a polar graph showing an vertical field pattern of the multi-mode resonant wideband antenna in the XZ plane according to the first preferred embodiment of the present invention;

FIG. 4A is a polar graph showing an horizontal field pattern of the multi-mode resonant wideband antenna in the XY plane according to the first preferred embodiment of the present invention;

FIG. 4B is a polar graph showing an vertical field pattern of the multi-mode resonant wideband antenna in the XY plane according to the first preferred embodiment of the present invention; and

FIG. 5 is a diagram showing the return loss of the multi-mode resonant wideband antenna in different frequencies according to the first preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

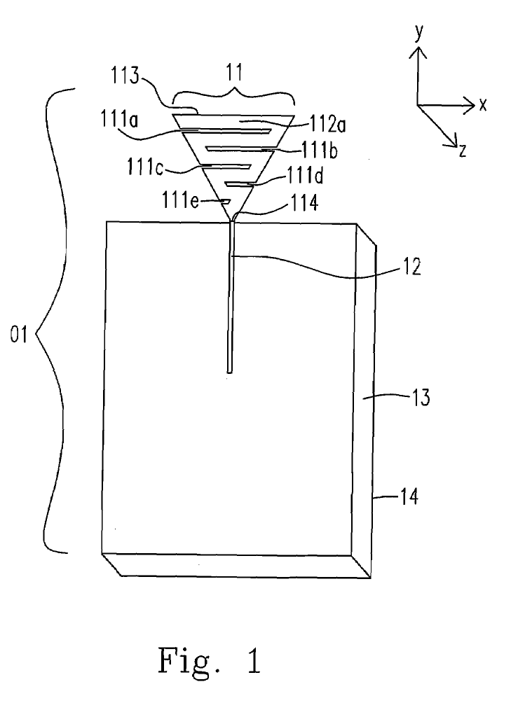

Please refer to FIG. 1, which is an illustrating diagram showing a multi-mode resonant wideband antenna according to the first preferred embodiment of the present invention. The multi-mode resonant wideband antenna 01 of the present invention includes a radiating element 11, a feeding line 12, a substrate 13, and a reference ground surface 14. The radiating element 11 further includes a metal piece having a shape of inverted triangle, and the metal piece has a first edge 113, a second edge 114, plural sections 112a-112e (of which only 112a is marked in FIG. 1) and plural cutouts 111a-111e. The number of cutouts could vary based on necessary in practice, as well as five cutouts 111a-111e exist in our embodiment. The respective cutouts 111a-111e have successively decreasing lengths, which makes the radiating element 11 have a zigzag shape. Further, the substrate 13 is a FR4 substrate.

In order to receive/transmit electromagnetic waves having different wavelengths, the length of the edges of radiating element 11 and each of the cutouts 111a-111e could be adjusted accordingly. In our first preferred embodiment, the first edge 113 has a length equal to a quarter wavelength of the electromagnetic wave having a frequency of 2.45 GHz, and the respective cutouts 111a-111e have a width of 20 milliinches, which is easy to be carried out by the present technology. Further, the sum of the length of the respective sections 112a-112e is equal to a half wavelength of the electromagnetic wave having a frequency of 2.45 GHz.

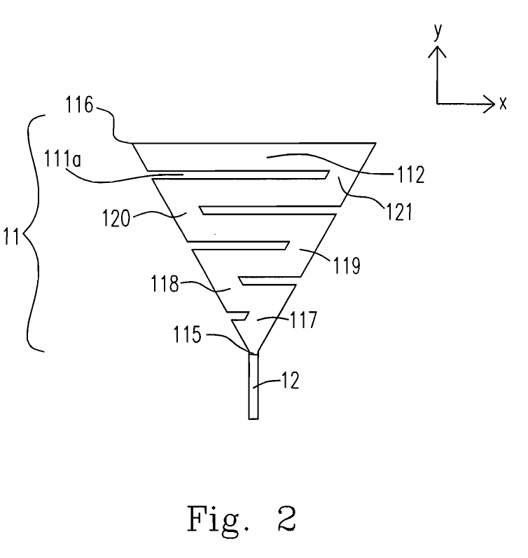

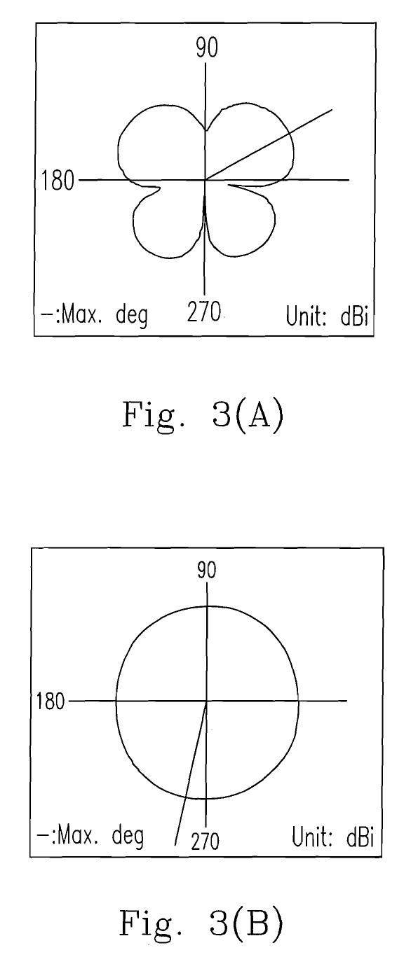

Please refer to FIG. 2, which is an illustrating diagram of a radiating element according to the second preferred embodiment of the present invention. The radiating element 11 includes a meander line 112 connected to the feeding line 12, and plural cutouts 111a-111e (only cutting slot 111a is marked in FIG. 2). The meander line 112 further includes a first terminal 115, a second terminal 116, plural sections 112a-112e (which is not shown in FIG. 2), and plural bending parts 117-121. As showed in FIG. 2, as providing a current to the first terminal 115 via the feeding line 12, the current would be transmitted from the first terminal 115 to the second terminal 116 via the meander line 112, which not only makes the respective sections 112a-112e have an individual horizontal electric field (−x/+x) but also makes each bending part 117-121 have a vertical electric field (+y). The horizontal electric fields of the respective sections 112a-112e would offset each other because of the alternatively opposite directions (−x/+x) thereof, and the vertical electric fields of each bending part 117-121 would superimpose each other because of the same direction (+y) thereof. In addition, as the total length of the meander line 112 (which is just the sum of the length of the respective sections 112a-112e and the individual bending parts 117-121) is equal to a half wavelength of the received electromagnetic wave, there would be a highest resonant current existing in the bending part 120 that is also the main site where the antenna radiates or receives the electromagnetic wave. Please refer to FIGS. 3A and 3B, which are polar graphs showing a horizontal and a vertical field patterns of the multi-mode resonant wideband antenna in the XZ plane according to the first preferred embodiment of the present invention. As the FIG. 3B shows, the sum of the electric fields in the vertical direction (+y) make the invented antenna being an omnidirectional antenna in XZ plane.

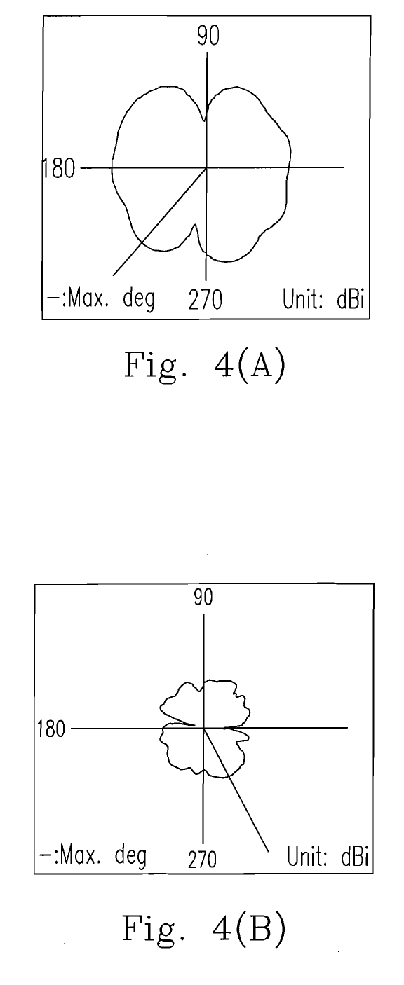

Please refer to FIGS. 4A and 4B, which are polar graphs showing a horizontal and a vertical field patterns of the multi-mode resonant wideband antenna in the XY plane according to the first preferred embodiment of the present invention. Because the cutouts 111a-111e have very narrow widths (20 milliinches), the respective sections 112a-112e have relatively broad widths, which decreases the impedance of the radiating element 11 and improves the invented antenna performance. As the FIG. 4A shows, the antenna of the present invention has an ideal performance of 3 dBi peak gain in the XY plane.

Further, since the cutouts 111a-111e have very narrow widths (20 milliinches), the multiple leakage currents would be induced easily across each cutouts 111a-111e, which makes the radiating element 11 have multiple effective electrical lengths from a quarter to a half wavelength of the received electromagnetic wave. Therefore, by coupling multiple effective electrical lengths, a broader bandwidth could be easily provided.

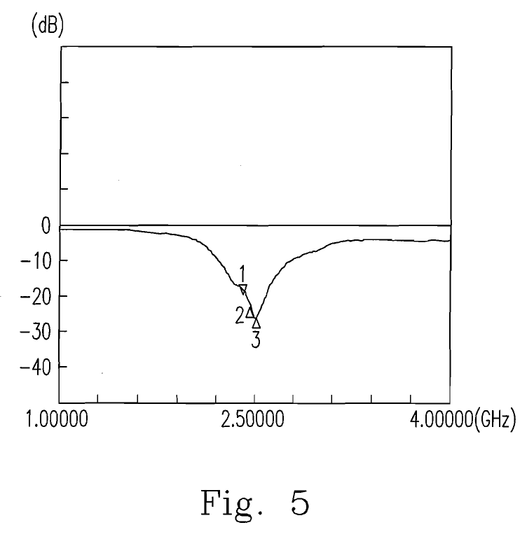

Please refer to FIG. 5, which is a diagram showing the return loss of the multi-mode resonant wideband antenna according to the first preferred embodiment of the present invention. The y-axis presents the return loss, and the x-axis presents, the operating frequencies. As described above, the radiating element 11 has an effective electrical length equal to a half wavelength of the received electromagnetic wave, which makes the radiating element 11 have a high vertical current in the bending part 120. A corresponding resonant frequency of 2.4 GHz could be found in FIG. 5, which is labeled as mark 1. Further, the bending part 120 is far away form the reference ground surface 14, which could decrease the interference induced by the ground 14. In addition, an effective electrical length equal to a quarter wavelength of the received electromagnetic wave would make the radiating element 11 have a high vertical current in the bending part 117. A corresponding resonant frequency of 2.5 GHz that is labeled as mark 3 could also be found in FIG. 5. Besides, the triangle-shaped radiating element 11 has the benefit of decreasing the coupling effect existing between the radiating element 11 and the reference ground surface 14. As the FIG. 5 shows, in an operational definition of −20 dB, the bandwidth of the invented antenna is 200 MHz. However, in an operational definition of −10 dB, the bandwidth of the invented antenna is 600 MHz. [0039] While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A wireless transmit/receive unit for transmitting and receiving an electromagnetic wave, comprising:
a radiating element being a metal piece having:
a first edge with a first length;
a second edge with a second length, wherein the first and second edges are separated from each other and the first length is longer than the second length; and
a plurality of cutouts formed on the metal piece and making the metal piece have a zigzag shape; and
a feeding line electrically connected to the second edge.

2. A wireless transmit/receive unit as claimed in claim 1, wherein the metal piece is one of an inverted triangle-shaped metal piece and an inverted trapezium-shaped metal piece.

3. A wireless transmit/receive unit as claimed in claim 1, wherein the first length is a multiple of a quarter wavelength of the electromagnetic wave.

4. A wireless transmit/receive unit as claimed in claim 1, wherein the metal piece having the zigzag shape has an effective electrical length that is a multiple of a half wavelength of the electromagnetic wave.

5. A wireless transmit/receive unit as claimed in claim 1, wherein the cutouts being cutting slots have a total length that is a multiple of a half wavelength of the electromagnetic wave.

6. A wireless transmit/receive unit as claimed in claim 1, wherein the cutouts are formed by one of a cutting process and an etching process.

7. A wireless transmit/receive unit as claimed in claim 1, wherein each of the cutouts being cutting slots has a width of 20 milliinches.

8. A wireless transmit/receive unit as claimed in claim 1, wherein the feeding line is further mounted on a dielectric substrate.

9. A wireless transmit/receive unit as claimed in claim 8, further comprising a reference ground surface connected to the dielectric substrate.

10. A wireless transmit/receive unit as claimed in claim 9, wherein the dielectric substrate is made of FR4.

11. A wireless transmit/receive unit as claimed in claim 1 configured in a wireless transmission device.

12. A wideband antenna transmitting/receiving an electromagnetic wave, comprising:
a meander line having a first terminal and a second terminal, comprising:
a first section having a first length and connected to the first terminal;
a first bend part;
a second section having a second length and connected to the first section via the first bending part;
a second bend part; and
a third section having a third length, connected to the second section via the second bend part and connected to the second terminal, wherein the first length is shorter than the second length, and the second length is shorter than the third length; and
a feeding line electrically connected to the first terminal.

13. A wideband antenna as claimed in claim 12, wherein the third length is a multiple of a quarter wavelength of the electromagnetic wave.

14. A wide band antenna as claimed in claim 12, wherein the meander line has a total length that is a multiple of a half wavelength of the electromagnetic wave.

15. A wideband antenna as claimed in claim 12, further comprising two slots between the first and second sections and the second and third sections respectively, wherein each of the slots has a width of 20 milliinches.

16. A wideband antenna as claimed in claim 12, wherein the feeding line is further mounted on a dielectric substrate.

17. A wideband antenna as claimed in claim 16 further comprising a reference ground surface, wherein the dielectric substrate is connected to the reference ground surface.

18. A method for increasing a bandwidth of an antenna, comprising the steps of:
providing a radiating element having a first edge with a first length and a second edge with a second length, wherein the first length is longer than the second length; and
forming a plurality of cutouts on the radiating element for producing a plurality of horizontal electric fields parallel to the cutouts and a plurality of vertical electric fields vertical to the cutouts, wherein the horizontal electric fields offset with each other and the vertical electric fields superimpose with each other.

19. A method as claimed in claim 18, wherein the cutouts are formed by one of a cutting process and an etching process.
